(19) United States
(12) Patent Application Publication
(10) Pub. No.: US 2025/0279960 A1
(43) Pub. Date: Sep. 4, 2025

(54) DISTRIBUTED SYSTEM, TRANSMISSION SCHEDULING METHOD, AND STORAGE MEDIUM

(71) Applicant: TENCENT TECHNOLOGY (SHENZHEN) COMPANY LIMITED, Shenzhen (CN)

(72) Inventors: Jianchao LV, Shenzhen (CN); Jinglin WANG, Shenzhen (CN); Zhi TAN, Shenzhen (CN); Mingxian BAO, Shenzhen (CN); Zhichao HOU, Shenzhen (CN); Da HU, Shenzhen (CN)

(21) Appl. No.: 19/210,264

(22) Filed: May 16, 2025

Related U.S. Application Data
(63) Continuation of application No. PCT/CN2024/081138, filed on Mar. 12, 2024.

(30) Foreign Application Priority Data
Apr. 20, 2023 (CN) 202310439284.3

(51) Int. Cl. H04L 45/42; H04L 47/2441

(52) U.S. Cl. CPC H04L 45/42; H04L 47/2441

(57) ABSTRACT

A distributed system includes a first routing node device, a second routing node device, and a global routing service node device, connected to a backbone network. The first routing node device is distributed in an access network and configured to access one or more Internet service provider (ISP) networks, and includes a universal service component and a first universal switching component. The second routing node device is distributed in a data center network and configured to provide data connection between network modules in the data center network, and includes a second universal switching component. The global routing service node device is arranged outside the access network and the data center network. A mapping relationship between peering connections and scheduling labels is maintained in the distributed system and transmitted between node devices. The node devices perform transmission scheduling of service packet in the cloud network based on the mapping relationship.

### CROSS-REFERENCES TO RELATED APPLICATIONS

This application is a continuation application of PCT Patent Application No. PCT/CN2024/081138, filed on Mar. 12, 2024, which claims priority to Chinese Patent Application No. 202310439284.3, filed on Apr. 20, 2023, all of which is incorporated herein by reference in their entirety.

### FIELD OF THE TECHNOLOGY

The present disclosure relates to the field of Internet technologies and, specifically, to a distributed system and a transmission scheduling method.

### BACKGROUND OF THE DISCLOSURE

At present, a network device, such as a commercial edge router (ER), may be deployed on a border of an Internet service provider (ISP) network; and a network device, such as a commercial internal router (IR), is deployed inside a data center network. Interconnection between the data center network and the ISP network can then be achieved, providing Internet services for massive objects. However, problems arises due to large specification (generally in millions) of Internet routing with narrow options of commercial routers, and features such as being expensive, poor function scalability, slow iteration speed, and high operation costs. It is difficult to meet actual needs in a cloud scenario.

### SUMMARY

One embodiment of the present disclosure provides a distributed system, applied to a cloud network, an architecture of the cloud network including an access network, a backbone network, and a data center network. The distributed system includes a first routing node device, a second routing node device, and a global routing service node device, that are connected to the backbone network, the first routing node device being distributed in the access network and being configured to access one or more Internet service provider (ISP) networks, the first routing node device including a universal service component and a first universal switching component, the second routing node device being distributed in the data center network and being configured to provide data connection between network modules in the data center network, the second routing node device including a second universal switching component, and the global routing service node device being arranged outside the access network and the data center network; and a mapping relationship between peering connections and scheduling labels being maintained in the distributed system, the mapping relationship being transmitted between node devices in the distributed system, and the node devices performing transmission scheduling of service packet in the cloud network based on the mapping relationship.

Another embodiment of the present disclosure provides a transmission scheduling method, applied to the a distributed system that includes a first routing node device, a second routing node device, and a global routing service node device, that are connected to a backbone network; the first routing node device being distributed in an access network and being configured to access one or more Internet service provider (ISP) networks, the first routing node device including a universal service component and a first universal switching component, the second routing node device being distributed in a data center network and being configured to provide data connection between network modules in the data center network, the second routing node device including a second universal switching component, and the global routing service node device being arranged outside the access network and the data center network; and a mapping relationship between peering connections and scheduling labels being maintained in the distributed system, the mapping relationship being transmitted between node devices in the distributed system, and the node devices performing transmission scheduling of service packet in the cloud network based on the mapping relationship. The method includes obtaining the mapping relationship between the peering connection and the scheduling label; transmitting the mapping relationship between the node devices in the distributed system; and performing transmission scheduling on the service packet in the cloud network based on the mapping relationship.

Another embodiment of the present disclosure provides a non-transitory computer-readable storage medium containing a computer program that, when being executed, causes one or more processors to perform a transmission scheduling method, applied to a distributed system that includes a first routing node device, a second routing node device, and a global routing service node device, that are connected to a backbone network; the first routing node device being distributed in an access network and being configured to access one or more Internet service provider (ISP) networks, the first routing node device including a universal service component and a first universal switching component, the second routing node device being distributed in a data center network and being configured to provide data connection between network modules in the data center network, the second routing node device including a second universal switching component, and the global routing service node device being arranged outside the access network and the data center network; and a mapping relationship between peering connections and scheduling labels being maintained in the distributed system, the mapping relationship being transmitted between node devices in the distributed system, and the node devices performing transmission scheduling of service packet in the cloud network based on the mapping relationship. The method includes obtaining the mapping relationship between the peering connection and the scheduling label; transmitting the mapping relationship between the node devices in the distributed system; and performing transmission scheduling on the service packet in the cloud network based on the mapping relationship.

### BRIEF DESCRIPTION OF THE DRAWINGS

FIG. 1 is a schematic diagram of an architecture of a distributed system according to an exemplary embodiment of the present disclosure.

FIG. 2 is a schematic flowchart of a transmission scheduling method according to an exemplary embodiment of the present disclosure.

FIG. 3 is a schematic diagram of performing routing information transmission in a routing system according to an exemplary embodiment of the present disclosure.

FIG. 4 is a schematic diagram of synchronizing forwarding information according to an exemplary embodiment of the present disclosure.

FIG. 5 is a schematic flowchart of performing transmission scheduling on an outbound service packet in a cloud network according to an exemplary embodiment of the present disclosure.

FIG. 6a is a schematic flowchart of performing transmission scheduling on an outbound service packet in a cloud network according to another exemplary embodiment of the present disclosure.

FIG. 6b is a schematic flowchart of performing transmission scheduling on an outbound service packet in a cloud network according to another exemplary embodiment of the present disclosure.

FIG. 7 is a schematic diagram of refined scheduling according to an exemplary embodiment of the present disclosure.

FIG. 8a is a schematic flowchart of performing transmission scheduling on an inbound service packet in a cloud network according to an exemplary embodiment of the present disclosure.

FIG. 8b is a schematic flowchart of performing transmission scheduling on an inbound service packet in a cloud network according to another exemplary embodiment of the present disclosure.

FIG. 9 is a schematic flowchart of performing transmission scheduling on an inbound attack traffic in a cloud network according to an exemplary embodiment of the present disclosure.

FIG. 10 is a schematic flowchart of a transmission scheduling method according to another exemplary embodiment of the present disclosure.

FIG. 11 is a schematic flowchart of a transmission scheduling method according to another exemplary embodiment of the present disclosure.

FIG. 12 is a schematic flowchart of a transmission scheduling method according to another exemplary embodiment of the present disclosure.

### DESCRIPTION OF EMBODIMENTS

### 1. Cloud Network

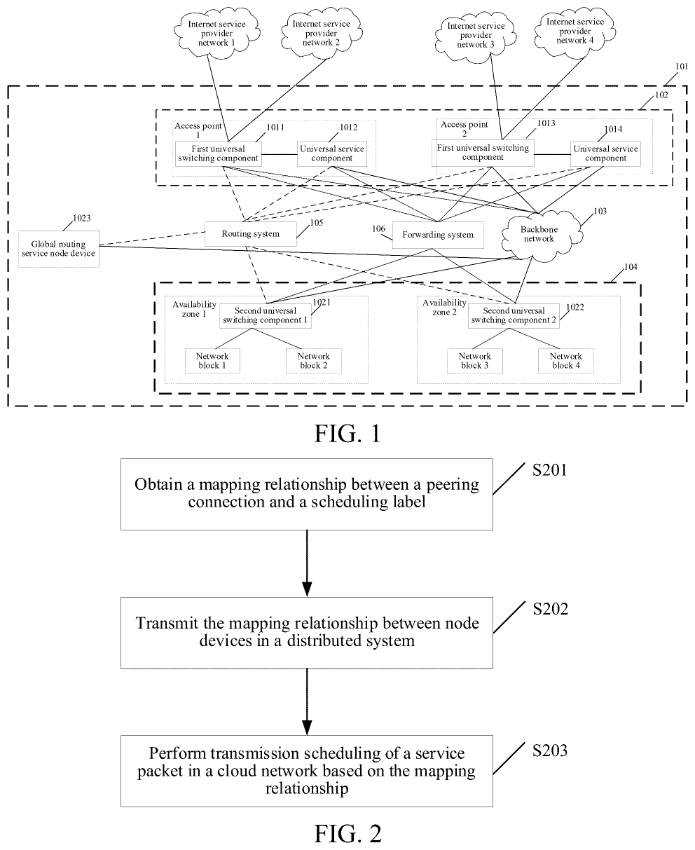

The cloud network is a network that performs service processing based on a cloud technology. An embodiment of the present disclosure provides an architecture of a cloud network. As shown in FIG. 1, an architecture of a cloud network 101 may include an access network 102, a backbone network 103, and a data center network 104. The following describes related concepts of networks in the cloud network, respectively.

### (1) Access Network

The access network is configured to access one or more Internet service provider (ISP) networks. The ISP is an operator providing an Internet service to an object. The Internet service may include, but is not limited to: an Internet access service, an information service, a value-added service, and the like. The object may be a service requester requesting the ISP to provide the Internet service. The ISP network is a network provided by the ISP and configured to provide the Internet service to the object. The ISP network is also referred to as a public network or an operator network, and is a portal for the object to enter the Internet. Different ISP networks (for example, an ISP network 1, an ISP network 2, an ISP network 3, and an ISP network 4 in FIG. 1) are provided by different ISPs.

The access network is a network configured to establish a connection between the ISP network and the data center network. The access network may include a plurality of point-of-presences (POPs). The POP may also be referred to as a network service providing point or a local end, is generally located at an edge of the cloud network, is used as an access point of the ISP network, and is configured to help the data center network to access the ISP network to enjoy the Internet service. Different POPs may be located in the same region or different regions, and each POP is configured to provide services to a specific region. For example, as shown in FIG. 1, the access network 102 includes a POP 1 and a POP 2. The POP 1 may be located in a city A, and is configured to provide services to the city A. The POP 2 may be located in a city B, and is configured to provide services to the city B. A region in which the POP is located may be the same as or different from a region served by the POP. For example, in the foregoing example, the POP 1 may be located in the city A, but may be configured to provide services to a city C.

### (2) Data Center Network

The data center network may also be referred to as an intranet network, and is a network constructed by a specific enterprise or organization that can provide network services such as storage, computing, or resources, and open only to persons and devices within the specific enterprise or organization. The data center network may include a plurality of availability zones (AZs). The AZ is one or more discrete physical data centers that are independent of each other in infrastructures such as electricity and a network in the same region. One AZ may include one or more network modules (nets), and the network module is an internal network that can provide network services to a region in the AZ. For example, as shown in FIG. 1, the data center network 104 may include an AZ 1 and an AZ 2. The AZ 1 may include a net 1 and a net 2.

### (3) Backbone Network

The backbone network is a network used as a communication hub between different networks in the cloud network and enabling different data center networks to be interconnected. Therefore, the backbone network may also be referred to as a data center interconnection (DCI) network.

In the architecture of the cloud network shown in FIG. 1: The access network 102 is connected to one or more ISP networks, the access network 102 is connected to the backbone network 103, and the data center network 104 is also connected to the backbone network 103. The cloud network is connected to one or more ISP networks, and the networks in the cloud network are interconnected, to provide Internet service services to massive (exceeding a preset quantity threshold) objects.

### 2. Border Gateway Protocol (BGP)

The BGP is configured to exchange routing information between different autonomous systems (ASs). The autonomous system is a set of devices that use the same policy under management of the same organization. In other words, different devices in a network may be divided into different autonomous systems (ASs), or all devices are divided into one autonomous system. Therefore, these devices in one autonomous system have the same routing protocol and are managed by one organization. In this case, communication between different autonomous systems is achieved through the BGP. In this embodiment of the present disclosure, an ISP network may be an AS.

### 3. Routing Information and Forwarding Information

The routing information is information configured for determining a transmission path of a packet, and is generated according to a routing algorithm. One piece of routing information may include three elements: a target address, a mask, and a next hop. The target address is an address of a network to which the packet is ultimately delivered. For example, the target address may be an address of the ISP network, or an address of the network module. The mask is a bit mask configured for indicating which bits in a network address identify a subnet at which a device is located, and which bits identify a bitmask of the device. The next hop is a next jump for routing a service packet. When the packet is not delivered to the target address, the packet may be transferred through the next hop until the packet is delivered to the target address. The routing information may be stored in a routing table, and any piece of routing information in the routing table may be referred to as a routing entry. The forwarding information is information configured for indicating a specific port to which the packet is transmitted, that is, information configured for determining an appropriate specific port from which the packet is to be forwarded. The forwarding information is generated based on the routing information. Specifically, a piece of forwarding information may be generated based on the routing information in the routing table in combination with other information (for example, information such as a network card or a port). The forwarding information may be stored in a forwarding table, and any piece of forwarding information in the forwarding table may be referred to as a forwarding entry.

In this embodiment of the present disclosure, routing information in the ISP network is referred to as public network routing information, and a specification of the public network routing information may generally reach millions. Routing information in the data center network may be referred to as intranet routing information. Generally, a specification of the intranet routing information has only hundreds of K (that is, hundreds of thousands). The specification is a quantity of pieces of routing information. After the ISP network is connected to the cloud network, the public network routing information is provided by the ISP network to the cloud network. Therefore, in subsequent embodiments of the present disclosure, full routing information of the cloud network includes the public network routing information and the intranet routing information.

### 4. Peering Connection

The peering connection, that is, peer, means that when establishing a communication connection, two devices do not distinguish which device is a service requester or a service provider, and the two devices that have established the peer can achieve equal and peer communication. In this embodiment of the present disclosure, a peer is a communication connection established between a first universal switching component (for example, an edge access switch (EAS)) in the access network and any ISP network to which the first universal switching component is connected. A peer is allocated with a mapped scheduling label (label), and the label may be configured for transmission scheduling of the service packet.

### 5. Cloud Technology

The cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient. A backend service of a technical network system requires a large amount of computing and storage resources, such as a video website, an image website, and more portal websites. As the Internet industry is highly developed and applied, each article may have its own identifier in the future and needs to be transmitted to a backend system for logical processing. Data at different levels is separately processed, and data in various industries requires strong system support, which can only be implemented through cloud computing. Therefore, the cloud technology becomes an important support.

### 6. Cloud Computing

The cloud computing is a mode of delivery and use of IT infrastructure, and is obtaining required resources in an on-demand and easily scalable manner through a network. The cloud computing in a broad sense is a mode of delivery and use of services, and is obtaining required services in an on-demand and easily scalable manner through a network. Such services may be related to the IT, software, and the Internet, or may be other services. The cloud computing is a product of development and convergence of computer and network technologies such as grid computing, distributed computing, parallel computing, utility computing, network storage technologies, virtualization, and load balance. The cloud computing grows rapidly with development of Internet, real-time data streaming, diversity of connection devices, and demands for searching service, social network, mobile commerce, and open collaboration. Unlike previous parallel distributed computing, generation of the cloud computing conceptually promote changes in an entire Internet mode and enterprise management mode.

A related description of a distributed system provided in the embodiments of the present disclosure is provided below.

FIG. 1 is a schematic diagram of an architecture of a distributed system according to an exemplary embodiment of the present disclosure. The distributed system may be used in the cloud network 101. The distributed system may include a first routing node device, a second routing node device, and a global routing service node device.

1. The first routing node device may be distributed in the access network 102, and is configured to access one or more ISP networks. The first routing node device is connected to the backbone network, so that the access network 102 and the backbone network 103 are connected to each other. In one embodiment, the first routing node device may include a first universal switching component and a universal service component.

In one embodiment, the access network 102 includes a plurality of POPs. That the first routing node device is distributed in the access network means that: At least one first routing node device is arranged in each POP. One first routing node device includes one first universal switching component and one universal service component, and both the first universal switching component and the universal service component are connected to the backbone network. As shown in FIG. 1, one first routing node device is respectively arranged in a POP 1 and a POP 2. The first routing node device in the POP 1 may include a first universal switching component 1011 and a universal service component 1012, and both the first universal switching component 1011 and the universal service component 1012 are connected to the backbone network 103. The first routing node device in the POP 2 may include a first universal switching component 1013 and a universal service component 1014, and both the first universal switching component 1013 and the universal service component 1014 are connected to the backbone network 103.

The first universal switching component may be configured to connect to one or more ISP networks, respectively establish peers with accessed ISP networks through the BGP, and allocate a mapped label to each peer. A peer is mapped to a label (that is, there is a mapping relationship between a peer and a label). For example, the first universal switching component 1011 is respectively connected to an ISP network 1 and an ISP network 2. In this case, the first universal switching component 1011 establishes a peer (marked as a peer 1-1) with the ISP network 1, and allocates a mapped label 1-1 to the peer 1-1. Similarly, the first universal switching component 1011 establishes a peer (a peer 1-2) with the ISP network 2, and allocates a mapped label 1-2 to the peer 1-2. For another example, the first universal switching component 1013 is respectively connected to an ISP network 3 and an ISP network 4. In this case, the first universal switching component 1013 establishes a peer (marked as a peer 2-1) with the ISP network 3, and allocates a mapped label 2-1 to the peer 2-1. Similarly, the first universal switching component 1013 establishes a peer (marked as a peer 2-2) with the ISP network 4, and allocates a mapped label 2-2 to the peer 2-2. The first universal switching component that has established a peer may perform equal and peer communication with the ISP network. For example, the first universal switching component may include an edge access switch (EAS). The EAS may be a programmable switch with low costs, for example, the EAS may be a P4 switch.

The universal service component may include an elastic packet processing (epp) server. The epp server may be a universal server. The universal service component may be configured to perform refined transmission scheduling on a service packet in the cloud network. The so-called refined transmission scheduling means that the service packet in the cloud network can be flexibly customized to perform transmission scheduling. The universal server may be an independent physical server, or may be a server cluster formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

2. The second routing node device may be distributed in the data center network 104, and is configured to provide data connection to network modules inside the data center network 104, so that data exchange can be performed between the network modules inside the data center network 104.

The data center network 104 includes one or more AZs, and each AZ includes one or more nets. That the second routing node device is distributed in the data center network means that: At least one second routing node device is arranged in each Az. One second routing node device includes at least one second universal switching component, and the second universal switching component is connected to the backbone network. The second universal switching component is respectively connected to nets that belong to the same AZ, so as to provide data connection to nets that are in the same AZ. For example, the data center network shown in FIG. 1 includes an AZ 1 and an AZ 2, the AZ 1 includes a net 1 and a net 2, and the AZ 2 includes a net 3 and a net 4. One second routing node device is respectively arranged in the AZ 1 and the AZ 2. The second routing node device in the AZ 1 includes a second universal switching component 1021, and the second universal switching component 1021 is respectively connected to the net 1 and the net 2. The second routing node device in the AZ 2 includes a second universal switching component 1022, and the second universal switching component 1022 is respectively connected to the net 3 and the net 4.

The second universal switching component may include an internal aggregate switch (IAS), and the IAS may be a programmable switch with low costs, for example, the IAS may be a P4 switch.

3. A global routing service node device 1023 is arranged outside the access network 102 and the data center network 104, and is connected to the backbone network 103. The global routing service node device 1023 may include an elastic routing service (ERS) server, a global routing service program is deployed on the ERS server, and the global routing service program in the ERS server is deployed in a physical manner or a virtual manner. In one embodiment, deployed in the physical manner means that the global routing service program may be deployed on the ERS server through physical hardware. In another implementation, “deployed in the virtual manner” means that the global routing service program may be deployed on the ERS server through virtual software.

Networks in the architecture of the cloud network each has a hierarchical structure. The backbone network is located at a bottom layer, and the access network and the data center network are located at an upper layer of the backbone network. Upper layer networks (that is, the access network and the data center network) may achieve data connection through the bottom-layer backbone network. Above the bottom-layer backbone network, a forwarding system and a routing system in the distributed system may further be established.

4. A routing system 105 in the distributed system is a routing plane (Routing System) in an entire distributed system. The so-called routing plane is a functional module responsible for routing management and control. The routing plane determines a transmission path of a packet in a network and a decision about how to forward the packet. For example, the routing system 105 may be referred to as a Tencent virtual private network (TVPN) system. The routing system may include the global routing service node device and a routing service instance deployed in the distributed system. The routing service instance may be an instance generated by using the Tencent virtual private network. The routing service instance may be referred to as a TVPN instance, and the routing service instance is configured to provide a routing service for a component. For example, the routing service instance may be understood as a routing table. In an embodiment, the routing service instance may be respectively deployed on the universal service component, the first universal switching component, and the second universal switching component. The routing system includes a routing service instance deployed on the universal service component, a routing service instance deployed on the first universal switching component, a routing service instance deployed on the second universal switching component, and the global routing service node device. In this case, these components (including the universal service component, the first universal switching component, and the second universal switching component) on which the routing service instances are deployed are components in the routing system. Each component on which the routing service instance is deployed may obtain and store routing information transmitted by the global routing service node device.

The routing system may perform routing information exchange based on a mapping relationship between a peer and a label. Specifically, node devices (including the first routing node device, the second routing node device, and the global routing node device) in the distributed system may exchange routing information of the cloud network in the routing system. The routing information includes the mapping relationship between the peer and the label.

Each component in the routing system has a respective routing plane, and the routing plane of each component in the routing system determines a transmission path of the packet at each component in the routing system and a decision about how to forward the packet. The routing plane of each component in the routing system is deployed and run in a CPU subsystem of each component in the routing system. For example, a routing plane of the EAS is deployed and run in a CPU subsystem of the EAS; and a routing plane of the IAS is deployed and run in a CPU subsystem of the IAS. Each component in the routing system obtains, in the respective routing plane, the routing information transmitted by the global routing service node device, to further stores the full routing information of the cloud network.

5. A forwarding system 106 is a forwarding plane (forwarding fabric) in the entire distributed system. The so-called forwarding plane is a functional module responsible for executing a forwarding decision to perform actual packet forwarding. For example, the forwarding system 106 may be referred to as a Tencent egress peering engineering (TEPE) system. The forwarding system may include a forwarding plane of the universal service component, a forwarding plane of the first universal switching component, and a forwarding plane of the second universal switching component. In this case, the universal service component, the first universal switching component, and the second universal switching component are components in the forwarding system. The forwarding plane of each component in the forwarding system is configured to execute a forwarding decision on a packet at each component in the forwarding system, to perform actual forwarding on the packet at each component in the forwarding system. The forwarding plane of each component in the forwarding system is generally deployed and run in an application specific integrated circuit (ASIC) subsystem of each component in the forwarding system. For example, a forwarding plane of the EAS is deployed and run in an ASIC subsystem of the EAS; and a forwarding plane of the IAS is deployed and run in an ASIC subsystem of the IAS. For example, the ASIC subsystem may be an ASIC chip. The mapping relationship between the peer and the label is maintained in the distributed system. The node devices in the distributed system may perform, in the forwarding system, transmission scheduling on the service packet based on the mapping relationship. The transmission scheduling herein may be specifically performing forwarding processing on the service packet based on routing information.

Each component in the forwarding system maintains a respective local forwarding table. Each component in the forwarding system may synchronize forwarding information in a respective forwarding plane based on the respective stored full routing information of the cloud network. The forwarding information synchronized by each component in the forwarding system is stored in the respective local forwarding table, and the local forwarding table of each component in the forwarding system includes a label. When transmission scheduling of the service packet needs to be performed, each component in the forwarding system may perform transmission scheduling on the service packet in the cloud network based on the label in the local forwarding table.

Based on interaction among the node devices in the distributed system shown in FIG. 1, the transmission scheduling method provided in the embodiments of the present disclosure can be implemented. FIG. 2 is a schematic flowchart of a transmission scheduling method according to an exemplary embodiment of the present disclosure. The transmission scheduling method includes the following operations S201 to S203.

S201. Obtain a mapping relationship between a peer and a label.

In an embodiment, when the first universal switching component accesses one or more ISP networks, the first universal switching component may respectively establish peers with the accessed ISP networks through the BGP, and allocate a mapped label to each peer. One peer is a communication connection established between one first universal switching component and one ISP network connected to the first universal switching component, and one peer is mapped to one label.

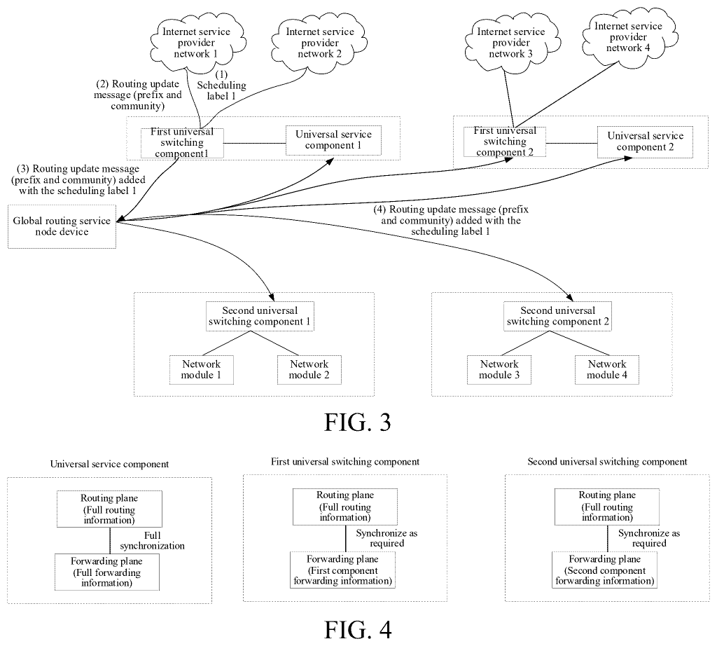

For example, FIG. 3 is a schematic diagram of performing routing information transmission in a routing system according to an exemplary embodiment of the present disclosure. A first universal switching component 1 accesses two ISP networks, which are respectively an ISP network 1 and an ISP network 2. The first universal switching component 1 may establish a peer 1 with the ISP network 1 through the BGP, and allocate a mapped label 1 to the peer 1. The first universal switching component 1 may establish a peer 2 with the ISP network 2 through the BGP, and allocate a mapped label 2 to the peer 2.

Further, the first universal switching component may store the mapping relationship between the peer and the label. As shown in an example shown in FIG. 3, the first universal switching component 1 may store a mapping relationship between the peer 1 and the label 1, and store a mapping relationship between the peer 2 and the label 2. In one embodiment, the first universal switching component may locally deliver the mapping relationship between the peer and the label. The so-called local delivering is delivering the mapping relationship between the peer and the label to the forwarding plane of the first universal switching component. In this way, during subsequent transmission scheduling, the first universal switching component may directly perform transmission scheduling (for example, forwarding processing) on the service packet based on the mapping relationship in the forwarding plane.

If the first universal switching component accesses N ISP networks, N peers are established, and N mapping relationships are locally delivered. In the foregoing example, if the first universal switching component establishes the peer 1 and the peer 2, mapping relationships corresponding to the two peers are locally delivered, that is, the mapping relationship between the peer 1 and the label 1 and the mapping relationship between the peer 2 and the label 2 are locally delivered.

S202. Transmit a mapping relationship between node devices in a distributed system.

In an embodiment, the node devices in the distributed system exchange routing information of the cloud network in the routing system. The routing information includes the mapping relationship between the peer and the label. Specifically, the global routing service node device in the routing system is responsible for collecting the routing information of the cloud network and transmitting the routing information of the cloud network to each component in the routing system. In one embodiment, the global routing service node device includes an ERS server. The ERS server may transmit, through the global routing service program, the routing information of the cloud network to each component in the routing system on which the routing service instance is deployed.

The global routing service node device in the routing system is responsible for collecting the routing information of the cloud network, and transmitting the routing information of the cloud network to each component in the routing system, which may include the following two cases: Case 1. Each component in the routing system may send the routing information to the global routing service node device, and the global routing service node device may summarize the routing information sent by each component in the routing system after receiving the routing information, and transmit all the summarized routing information to each component in the routing system. Case 2. After receiving routing information sent by any component in the routing system, the global routing service node device transmits, to another component in the routing system, the received routing information sent by any component.

Routing information related to a peer includes a label mapped to the peer. For example, there is a mapping relationship between a peer 1 and a label 1, and routing information related to the peer 1 includes the label 1. The routing information includes three elements: a target address, a mask, and a next hop. Therefore, the routing information related to the peer may be understood as follows: The target address is a device address (for example, an address of the first universal switching component, or an address of an ISP network) corresponding to the peer; or the next hop is a device address corresponding to the peer; or the mask is a mask of a device corresponding to the peer.

In an embodiment, when sending, to the global routing service node device, routing information of each ISP network accessed to the first universal switching component, the first universal switching component may determine a peer related to each ISP network, and encapsulate a label mapped to the peer in the routing information of each ISP network. The first universal switching component sends, to the global routing service node device, routing information of each ISP network encapsulated with the label. For example, a peer 1 is established between a first universal switching component and an ISP network 1, and a peer 2 is established between the first universal switching component and an ISP network 2, the first universal switching component encapsulates a label 1 mapped to the peer 1 in routing information of the ISP network 1, encapsulates a label 2 mapped to the peer 2 in routing information of the ISP network 2, and sends, to a global routing service node device, the routing information of the ISP network 1 encapsulated with the label 1 and the routing information of the ISP network 2 encapsulated with the label 2.

When receiving the routing information, sent by the first universal switching component, of each ISP network encapsulated with the label, the global routing service node device may transmit the routing information of each ISP network encapsulated with the label to each component in the routing system, so that each component in the routing system stores the routing information encapsulated with the label.

When the routing information of the cloud network is updated, the global routing service node device may transmit updated routing information to each component in the routing system. That the routing information of the cloud network is updated may include: Routing information related to each component in the routing system changes, or a route change brought by each component in the routing system accessing a new network. For example, when the first universal switching component receives a routing update message from an accessed ISP network, it means that the routing information of the cloud network is updated. The routing update message includes updated routing information. The first universal switching component may add a label mapped to a peer related to the ISP network to the routing update message, and send the routing update message added with the label to the global routing service node device. The global routing service node device may transmit the routing update message added with the label to each component in the routing system, so that each component in the routing system updates routing information based on the routing update message added with the label.

In some embodiments, the routing update message is a BGP message, and a prefix and a community may be further added to the BGP message. The community is configured for identifying routes having the same feature, and this attribute is an optional transition.

That the first universal switching component receives the routing update message from the ISP network may include at least one of the following cases: Case 1. When the first universal switching component is first accessed to the ISP network, the first universal switching component receives the routing update message from the ISP network. Case 2. When an ISP network accessed by the first universal switching component changes, the first universal switching component receives the routing update message from the ISP network.

For ease of understanding, a process in which routing information related to an ISP network is transmitted to each component in a routing system is specifically described by using FIG. 3 as an example. A procedure of the transmission may include the following: (1) When a first universal switching component 1 accesses an ISP network 1, a peer (marked as a peer 1) is established with the ISP network 1, and a mapped label 1 is allocated to the peer 1. (2) The ISP network 1 sends a routing update message to the first universal switching component, where the routing update message includes updated routing information. (3) When receiving the routing update message, the first universal switching component 1 may add the label 1 to the routing update message, and send the routing update message added with the label 1 to the global routing service node device through the deployed routing service instance. (4) The global routing service node device may transmit, to each component in which the routing service instance is deployed in the routing system, the routing update message added with the label 1. As shown in FIG. 3, the global service node device may transmit the routing update message added with the label 1 to the universal service component 1, the universal service component 2, the first universal switching component 2, the second universal switching component 1, and the second universal switching component 2 in the routing system through the routing service instance. After receiving the routing update message added with the label 1, each component in the routing system may store the updated routing information and the label 1 that are included in the routing update message of the label 1.

Through transmission of the routing system, the global routing service node device and each component in the routing system store full routing information of the cloud network. In some embodiments, the full routing information of the cloud network stored by each component in the routing system may be stored in a respective routing plane of each component in the routing system.

Further, each component in the routing system may synchronize forwarding information in a respective forwarding plane based on the full routing information of the cloud network stored in each component. There are certain differences in the forwarding information synchronized by the forwarding planes of different components. As shown in FIG. 4, FIG. 4 is a schematic diagram of synchronizing forwarding information by each component according to an exemplary embodiment of the present disclosure. For the universal service component, the universal service component may synchronize the full forwarding information of the cloud network on the forwarding plane of the universal service component based on the full routing information stored by the universal service component, and the full forwarding information of the cloud network synchronized on the forwarding plane of the universal service component may be stored in a local forwarding table of the universal service component. In other words, the routing plane of the universal service component stores the full routing information, and the forwarding plane of the universal service component also stores the full forwarding information. Storing the full forwarding information on the forwarding plane of the universal service component may be configured for subsequently performing refined scheduling and transmission on the service packet. The full forwarding information may include forwarding information related to the ISP network, forwarding information related to a network module in the data center network, and the like. The full forwarding information includes the label mapped to the peer. Because the forwarding information is generated based on the routing information, the forwarding information related to the ISP network may be understood as being generated based on the routing information related to the ISP network. The routing information includes three elements: a target address, a mask, and a next hop. Therefore, the routing information related to the ISP network may be understood as follows: The target address is an address of the ISP network; or the next hop is an address of the ISP network; or the mask is a mask of the ISP network.

For the first universal switching component and the second universal switching component: In respective forwarding planes, the full forwarding information is not synchronized, but the forwarding information of the cloud network is synchronized as required. That the first universal switching component and the second universal switching component synchronize the forwarding information of the cloud network as required includes the following two reasons: 1. Because a quantity of pieces of public network routing information is in millions, the first universal switching component establishes a peer and allocates a mapped label when accessing the ISP network, the first universal switching component stores a mapping relationship between a label and a peer, and a quantity of peers is only in hundreds. When forwarding the service packet, the first universal switching component only needs to forward the service packet to a corresponding peer based on a label carried in the service packet, to achieve scheduling of peer granularity. Therefore, the first universal switching component does not need to synchronize the full forwarding information. In this embodiment of the present disclosure, a mapping relationship between a label and a peer may be referred to as a TEPE entry. 2. The intranet routing information belongs to internal network planning of the data center network. Therefore, a quantity of pieces of the intranet routing information is less than the quantity of pieces of public network routing information, and can be directly delivered to the forwarding planes of the first universal switching component and the second universal switching component.

Based on the foregoing two reasons, the first universal switching component may synchronize first component forwarding information of the cloud network on the forwarding plane of the first universal switching component as required based on the full routing information stored by the first universal switching component. The first component forwarding information includes forwarding information related to the ISP network accessed to the first universal switching component. The forwarding information related to the ISP network accessed to the first universal switching component includes the TEPE entry. In an embodiment, the first component forwarding information further includes: forwarding information related to the network module.

The synchronizing first component forwarding information of the cloud network on the forwarding plane of the first universal switching component as required may be that: The first universal switching component determines the ISP network accessed to the first universal switching component, generates the first component forwarding information based on routing information related to the ISP network accessed to the first universal switching component, and synchronizes the first component forwarding information in the forwarding plane of the first universal switching component. The routing information related to the ISP network accessed to the first universal switching component includes the label mapped to the peer related to the ISP network. In some embodiments, the synchronized first component forwarding information of the cloud network is stored in the local forwarding table of the first universal switching component.

The first component forwarding information includes all TEPE entries. In other words, if the first universal switching component establishes peers with 10 ISP networks, a quantity of mapping relationships between the peer and the label is 10, and the first component forwarding information includes 10 TEPE entries. The first component forwarding information is synchronized in the forwarding plane of the first universal switching component, so that when the first universal switching component forwards the service packet, the first universal switching component only needs to forward the service packet to a corresponding peer based on the label carried in the service packet, to achieve peer-level scheduling, and no longer need based on millions of public network routing and forwarding. In this embodiment of the present disclosure, a forwarding mode corresponding to the peer-level may be referred to as TEPE forwarding.

The second universal switching component synchronizes second component forwarding information of the cloud network on the forwarding plane of the second universal switching component as required based on the full routing information stored by the second universal switching component. The second component forwarding information includes forwarding information related to a net that belongs to the same AZ as the second universal switching component. The synchronizing second component forwarding information of the cloud network on the forwarding plane of the second universal switching component as required may be that: The second universal switching component determines the net that belongs to the same AZ as the second universal switching component, generates, based on the full routing information stored by the second universal switching component, the forwarding information related to the net that belongs to the same AZ, generates second component forwarding information based on the forwarding information related to the net that belongs to the same AZ, and synchronizes the second component forwarding information in the forwarding plane of the second universal switching component. The synchronized second component forwarding information of the cloud network is stored in the local forwarding table of the second universal switching component.

In some embodiments, the second component forwarding information further includes: the forwarding information related to the ISP network. That is, the forwarding information related to the ISP network is synchronized as required in the second universal switching component. In this way, a pressure of outbound traffic on a universal service component side can be reduced or shared in a scenario of an elephant flow or in a scenario in which refined scheduling does not need to be performed on the service packet. The elephant flow is a process of continuously transmitting a large quantity of ordinary service packets during network transmission.

Through the foregoing synchronization of the full forwarding information in the universal service component and synchronization of the forwarding information in the first universal switching component and the second universal switching component as required, a large quantity (for example, millions) of public network forwarding entries can be compressed into a small quantity (for example, hundreds) of TEPE entries, thereby achieving millions of public network routing and forwarding on limited entry storage space of the foregoing ASIC subsystem (for example, the ASIC chip). The entry storage space is storage space configured for storing forwarding entries.

S203. Perform transmission scheduling on a service packet in a cloud network based on the mapping relationship.

A forwarding system in the distributed system may perform transmission scheduling on the service packet in the cloud network based on the mapping relationship. Specifically, each node device in the distributed system performs, in the forwarding system, transmission scheduling on the service packet in the cloud network based on the mapping relationship. In one embodiment, components included in each node device perform transmission scheduling on the service packet in the cloud network based on forwarding information in respective local forwarding tables. When the service packet in the cloud network reaches any component in the forwarding system, the any component queries a local forwarding table of the any component for forwarding information required for transmission. If the query succeeds, any component encapsulates a label related to transmission in the service packet based on the found forwarding information, and performs forwarding processing on the service packet based on an indication of the found forwarding information; or if the query fails, any component sends the service packet to a default next hop, and a component to which the default next hop points performs transmission scheduling on the service packet.

The service packet may include an inbound service packet and an outbound service packet. The inbound service packet is a service packet transmitted from the ISP network to the data center network. The outbound service packet is a service packet transmitted from the data center network to the ISP network. A process of performing, by each component in the forwarding system, transmission scheduling on the service packet in the cloud network based on the forwarding information in the respective local forwarding table is described in detail in subsequent embodiments from the inbound service packet and the outbound service packet. Details are not described herein again.

In summary, the distributed system in the embodiments of the present disclosure includes the first routing node device, the second routing node device, and the global routing service node device. The first routing node device includes the universal service component and the first universal switching component. The second routing node device includes the second universal switching component. It can be learned that in the present disclosure, the distributed system is built by replacing a commercial router with a low-price universal component, so that a large-scale commercial router can be decoupled, operation can be greatly simplified, and operation costs can be reduced, thereby improving scalability and flexibility of the distributed system. In addition, the routing system provides the label for each component in the forwarding system by transmitting the mapping relationship between the label and the peer. According to the transmission scheduling method implemented based on the distributed system, in a public network scenario, a problem that a stored forwarding entry is insufficient due to limited storage space of a universal switching component is resolved. A T-level forwarding specification (the T-level forwarding specification is a value of a forwarding bandwidth, where 1 T=1024 G, that is, a forwarding bandwidth of 1024 G may be supported) is supported, and a routing specification may be reduced, to process millions routing and forwarding on a switching chip in hundreds of K (that is, a quantity of routing and forwarding that can be processed by the switching chip is hundreds of K), thereby achieving high-performance routing and forwarding and flexible transmission scheduling, and satisfying a transmission scheduling requirement of the cloud network.

Next, the process of performing, by each component in the forwarding system, transmission scheduling on the service packet in the cloud network based on the forwarding information in the respective local forwarding table is respectively described from the inbound service packet and the outbound service packet.

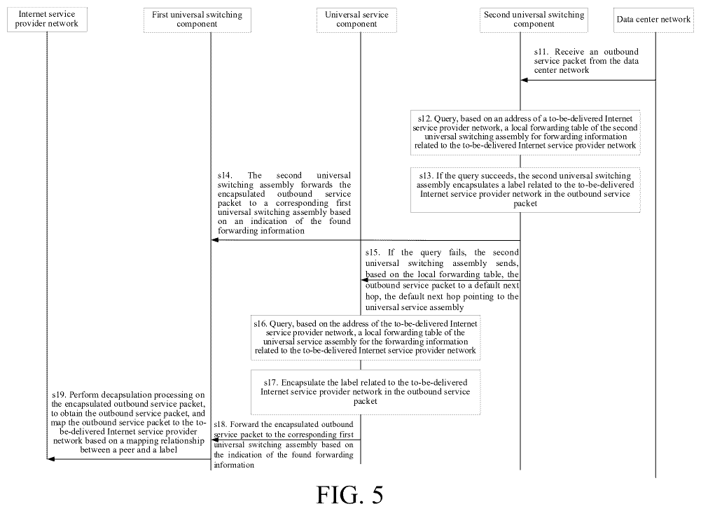

FIG. 5 is a schematic flowchart of performing transmission scheduling on an outbound service packet in a cloud network according to an exemplary embodiment of the present disclosure. A procedure of performing transmission scheduling on the outbound service packet in the cloud network includes the following operations: s11 to s19.

s11. A second universal switching component receives an outbound service packet from a data center network, the outbound service packet including an address of a to-be-delivered ISP network.

In an embodiment, the second universal switching component may receive an outbound service packet sent by a net connected to the second universal switching component in the data center network, and obtain the address of the to-be-delivered ISP network from the received outbound service packet. Then, operation s12 is performed. For example, the second universal switching component is connected to a net 1 in the data center network, and the second universal switching component may receive an outbound service packet sent by the net 1, and obtain the address of the to-be-delivered ISP network from the outbound service packet. The outbound service packet may include a response made by the net in the data center network when the net receives a service request sent by an object. For example, if the service request is a data query, the outbound service packet includes a query result returned for the data query.

s12: The second universal switching component queries a local forwarding table of the second universal switching component for forwarding information related to the to-be-delivered ISP network based on the address of the to-be-delivered ISP network. If the query succeeds, it indicates that there is explicit forwarding information in the local forwarding table of the second universal switching component for the outbound service packet, and then operation s13 to s14 may be performed. If the query fails, it indicates that there is no explicit forwarding information in the local forwarding table of the second universal switching component for the outbound service packet, and the service packet needs to be forwarded to a component storing the full forwarding information. That is, operation s15 to s18 are performed.

The local forwarding table of the second universal switching component records the second component forwarding information of the cloud network synchronized as required by the second universal switching component. The forwarding information related to the to-be-delivered ISP network may include: an address of a to-be-delivered ISP network, a next hop, a next hop port, a label, and the like. For example, the local forwarding table of the second universal switching component is shown in Table 1. The address of the to-be-delivered ISP network is xxx.xxx.xxx.xxx. The second general component may find forwarding information from Table 1 according to: .xxx.xxx.xxx. The forwarding information includes “A next hop is a first universal service component 1, a next hop port is a port A of the first universal service component 1, and a label is a label 1”.

TABLE 1

| Address of a to-be- | | | |
|---|---|---|---|
| delivered ISP network | Next hop | Next hop port | label |
| xxx.xxx.xxx.xxx | First universal | Port A of the first | label 1 |
| | service | universal | |
| | component 1 | service component 1 | |
| xxx.xxx.xxx.x11 | Second universal | B port of a | label 2 |
| | service | second universal | |
| | component 1 | service component 1 | |

s13. If the query succeeds, the second universal switching component encapsulates a label related to the to-be-delivered ISP network in the outbound service packet.

s14. The second universal switching component forwards the encapsulated outbound service packet to a corresponding first universal switching component based on an indication of the found forwarding information, and enters operation s19.

s15. If the query fails, the second universal switching component sends the outbound service packet to a default next hop, the default next hop pointing to a universal service component.

Specifically, the second universal switching component may encapsulate the outbound service packet to point to an address of a default next hop, and then forward the encapsulated outbound service packet to the default next hop. The local forwarding table of the universal service component records the full forwarding information of the cloud network.

s16. A universal service component queries, based on the address of the to-be-delivered ISP network, a local forwarding table of the universal service component for the forwarding information related to the to-be-delivered ISP network.

In an embodiment, the local forwarding table of the universal service component records the full forwarding information of the cloud network. The universal service component may obtain, after receiving the outbound service packet sent by the second universal switching component, the address of the to-be-delivered ISP network from the outbound service packet, and successfully find, based on the address of the to-be-delivered ISP network from the local forwarding table of the universal service component, the forwarding information related to the to-be-delivered ISP network. Then, operation s17 is performed.

s17. The universal service component encapsulates the label related to the to-be-delivered ISP network in the outbound service packet.

s18. The universal service component forwards the encapsulated outbound service packet to a corresponding first universal switching component based on an indication of the found forwarding information, then proceeds to s19.

s19. The first universal switching component performs decapsulation processing on the encapsulated outbound service packet, to obtain the outbound service packet, and maps, based on a mapping relationship between a peer and a label, the outbound service packet to the to-be-delivered ISP network.

In an embodiment, after receiving the encapsulated outbound service packet, the first universal switching component may perform decapsulation processing on the encapsulated outbound service packet, to obtain the outbound service packet and the label, determine, based on the mapping relationship between the peer and the label that is stored on the forwarding plane, a peer mapped to the label obtained through decapsulation, and directly map, through the peer, the outbound service packet to the to-be-delivered ISP network. Through the mapping relationship between the peer and the label, the first universal switching component does not need to query the local routing table.

For ease of understanding, an entire transmission scheduling process of the outbound service packet is described below by using two specific examples.

(1) The outbound service packet is transmitted from the net 1 in the data center network to the ISP network 1.

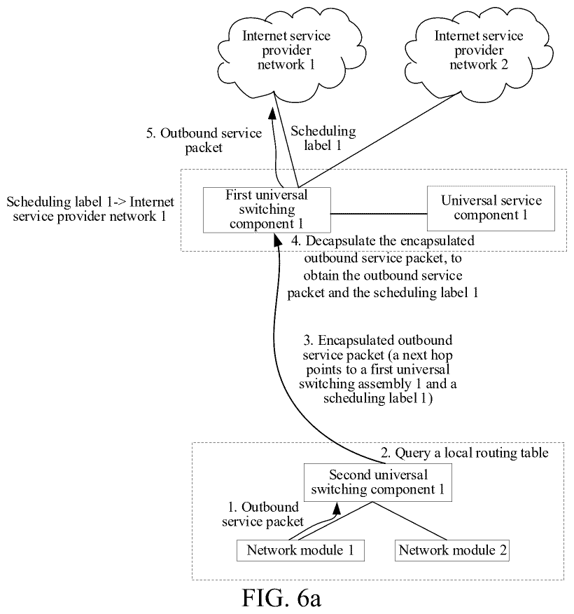

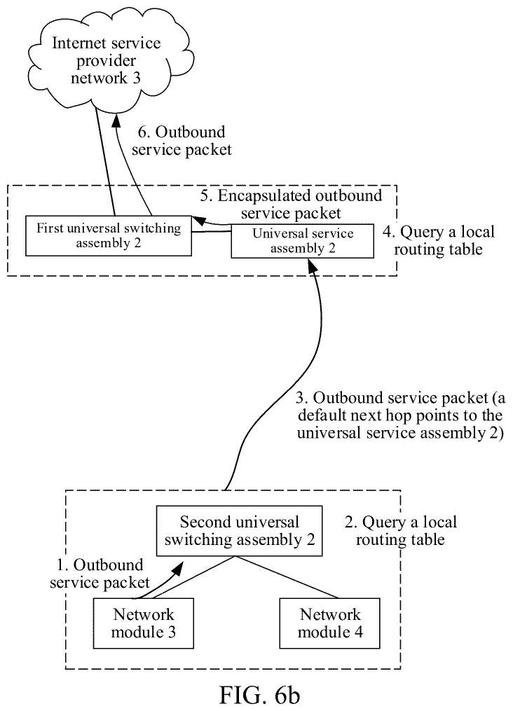

FIG. 6a is a schematic flowchart of performing transmission scheduling on an outbound service packet in a cloud network according to another exemplary embodiment of the present disclosure. A transmission scheduling procedure of the outbound service packet includes: 1. The second universal switching component 1 receives the outbound service packet from the net 1 in the data network center, the outbound service packet including the address of the to-be-delivered ISP 1. 2. The second universal switching component 1 may query, based on the address of the ISP network 1, a local forwarding table of the second universal switching component 1 for forwarding information related to the ISP network 1. In this case, the forwarding information related to the ISP network 1 is successfully found in the local forwarding table. For example, the found forwarding information related to the ISP network 1 includes: a label 1 related to the ISP network 1, a next hop points to the first universal switching component 1, and the like. The second universal switching component encapsulates the label 1 in the outbound service packet, to obtain the encapsulated outbound service packet. 3. The second universal switching component forwards the encapsulated outbound service packet to a corresponding first universal switching component 1 based on an indication of the found forwarding information. 4. The first universal switching component 1 may perform decapsulation processing on the encapsulated outbound service packet after receiving the encapsulated outbound service packet, to obtain the outbound service packet and the label 1, and determine, based on a mapping relationship between a label and a peer, a peer mapped to the label 1. 5. The outbound service packet is forwarded to an egress of the ISP network 1 based on the peer mapped to the label 1.

(2) The outbound service packet is transmitted from a net 3 in the data center network to an ISP network 3.

FIG. 6b is a schematic flowchart of performing transmission scheduling on an outbound service packet in a cloud network according to another exemplary embodiment of the present disclosure. A transmission scheduling procedure of the outbound service packet includes: 1. The second universal switching component 2 receives the outbound service packet from the net 3 in the data network center, the outbound service packet including an address of a to-be-delivered ISP network 3. 2. The second universal switching component 2 may query a local forwarding table of the second universal switching component 2 for forwarding information related to the ISP network 3 based on the address of the ISP network 3. 3. If the second universal switching component 2 fails to query for the forwarding information related to the ISP network 3, the second universal switching component 2 may send the outbound service packet to a default next hop, the default next hop pointing to the universal service component 2. 4. After receiving the outbound service packet, the universal service component 2 queries, based on the address of the ISP network 3, the local forwarding table of the universal service component 2 for the forwarding information related to the ISP network 3, where the found forwarding information related to the ISP network 3 includes: an address of the forwarding information related to the ISP network 3, a next hop (pointing to the first universal switching component 2), and a label 3. 5. The universal service component 2 encapsulates the label 3 in the outbound service packet, to obtain the encapsulated outbound service packet, and forwards the encapsulated outbound service packet to a corresponding first universal switching component 2 based on an indication of the found forwarding information. 6. After receiving the encapsulated outbound service packet, the first universal switching component 2 may perform decapsulation processing on the encapsulated outbound service packet, to obtain the outbound service packet and the label 3, then determine, based on a stored mapping relationship between a label and a peer, a peer mapped to the label 3, and directly forward, based on the peer mapped to the label 3, the outbound service packet to an egress of the ISP network 3.

As described above, when the outbound service packet is forwarded, the outbound service packet is forwarded based on the label, so that when forwarding the outbound service packet, the first universal switching component only needs to forward the outbound service packet to a corresponding peer based on the label carried in the outbound service packet, to achieve peer-level scheduling, and no longer need based on millions of public network routing and forwarding (that is, routing and forwarding does not need to be performed based on millions of public network routing information).

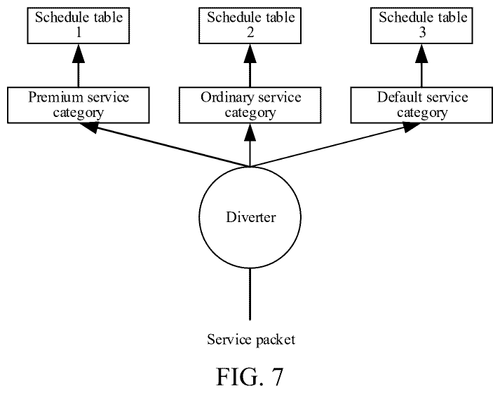

In addition, in this embodiment of the present disclosure, refined scheduling may be performed on the service packet (for example, the outbound service packet). In this case, in addition to storing the full routing information and the full forwarding information, the universal service component in the forwarding system may further configure a flow classification rule and a schedule table as required. The flow classification rule defines a classification rule of the service packet. One schedule table is configured for recording transmission information of service packets of one category. For example, FIG. 7 is a schematic diagram of refined scheduling according to an exemplary embodiment of the present disclosure. In FIG. 7, the classification rule of the service packet defined by the flow classification rule may be that: A service packet including voice content is defined as an ordinary service category, a service packet including a video is defined as a premium service category, and a service packet including text is defined as a default service category. The premium service category corresponds to a schedule table 1, and the schedule table 1 records transmission information of a service packet of the premium service category. The ordinary service category corresponds to a schedule table 2, and the schedule table 2 records transmission information of a service packet of the ordinary service category. The default service category corresponds to a schedule table 3, and the schedule table 3 records transmission information of a service packet of the default service category. For another example, the classification rule of the service packet defined by the flow classification rule may be that: A service packet with a high requirement on real-time performance is defined as a real-time service category, and a service packet with a low requirement on real-time performance is defined as a non-real-time service category.

Transmission information in one schedule table may include path information and egress information for transmitting service packets of one category. The transmission information in one schedule table may be comprehensively determined based on a category of the service packet, transmission quality of different egresses, and transmission costs. For example, for a service packet of a premium service category, transmission quality at an egress is required to be high and transmission costs at the egress are required to be high. In this case, the full routing information may be integrated to in the distributed system to find path information having high transmission quality and high transmission costs at the egress, to obtain path information and egress information for transmitting the service packet of the premium service category. For example, the path information may be: first universal switching component->an ISP network of Telecom, and the egress information may be “ISP network of Telecom”. For another example, for a service packet of a default service category, transmission quality at an egress is required to be low and transmission costs at the egress are required to be low. In this case, the full routing information may be integrated in the distributed system to find path information having low transmission quality and low transmission costs at the egress, to transmit path information and egress information of the service packet of the default service category. For example, the path information may be: first universal switching component->an ISP network of Unicom, and the egress information is “ISP network of Unicom”.

In this case, the performing transmission scheduling on a service packet in a cloud network may further include: classifying, by the universal service component, the service packet in the cloud network based on the flow classification rule, to obtain a category to which the service packet belongs; and performing transmission scheduling on the service packet based on transmission information recorded in a schedule table corresponding to the category to which the service packet belongs. In one embodiment, the universal service component is deployed with a diverter, and the universal service component calls the diverter to classify the service packet in the cloud network based on the flow classification rule, to obtain the category to which the service packet belongs. For example, in FIG. 7, the diverter is called to classify the service packet in the cloud network based on the flow classification rule, to obtain that a category to which the service packet belongs is a premium service category, and then the universal service component determines the schedule table 1 corresponding to the premium service category, and performs transmission scheduling on the service packet based on the transmission information recorded in the schedule table 1.

The service packet includes the outbound service packet. The universal service component may receive the outbound service packet from the second universal switching component, and choose, according to a requirement, to perform transmission scheduling on the outbound service packet based on the local forwarding table, or perform transmission scheduling on the outbound service packet in a refined scheduling manner. This is not limited in the embodiments of the present disclosure. In the foregoing manner, fine and customized flexible scheduling requirements based on a service and a flow in the cloud network can be satisfied, flexibility of transmission scheduling of the service packet in an entire cloud network is improved, and advantages are obvious in a plurality of dimensions such as costs, performance, and flexibility.

A related description is provided on a procedure of performing transmission scheduling on an inbound service packet in a cloud network.

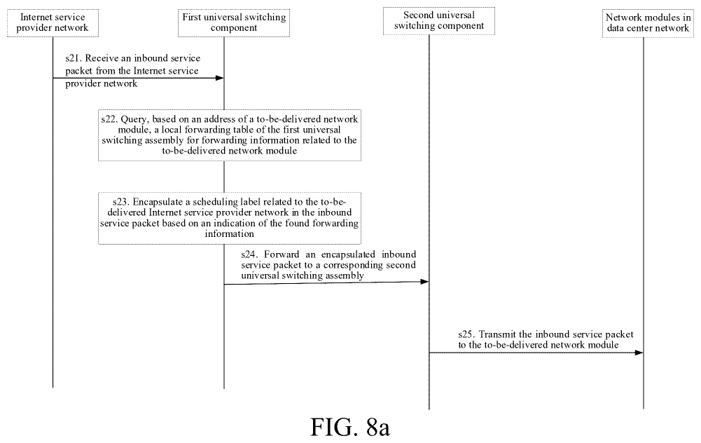

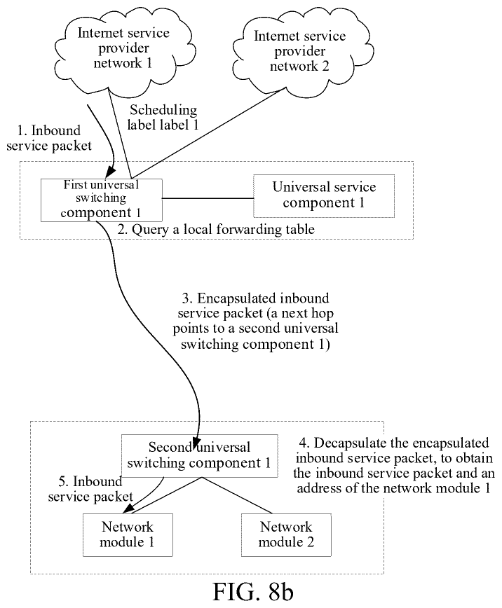

FIG. 8a is a schematic flowchart of performing transmission scheduling on an inbound service packet in a cloud network according to an exemplary embodiment of the present disclosure. The procedure of performing transmission scheduling on the inbound service packet in the cloud network includes the following operations s21 to s25.

s21. A first universal switching component receives an inbound service packet from an ISP network, the inbound service packet including an address of a to-be-delivered net in a data center network.

s22: The first universal switching component queries, based on the address of the to-be-delivered net, a local forwarding table of the first universal switching component for forwarding information related to the to-be-delivered net. The local forwarding table of the first universal switching component records first component forwarding information of the cloud network synchronized as required by the first universal switching component.

In one embodiment, forwarding of the inbound service packet depends on intranet forwarding information, and a quantity of pieces of intranet routing information is very small relative to a quantity of pieces of public network routing information, that is, the quantity of pieces of public network routing information has only hundreds of K. Therefore, when the forwarding plane of the first universal switching component and the forwarding plane of the second universal switching component perform synchronization as required, forwarding information related to all nets in the data center network is synchronized. Therefore, the first component forwarding information recorded in the local forwarding table of the first universal switching component includes forwarding information related to the to-be-delivered net, and the first universal switching component may obtain the address of the to-be-delivered net from the inbound service packet. Moreover, based on the address of the to-be-delivered net, forwarding information related to the to-be-delivered net can be successfully found from the local forwarding table of the first universal switching component, and then operation s23 is performed. The found forwarding information related to the to-be-delivered net may include: an address of a to-be-delivered net, a next hop, a next hop port, a label, and the like.

s23. The first universal switching component encapsulates a label related to an ISP network (that is, a label mapped to a peer related to the ISP network) in the inbound service packet based on an indication of the found forwarding information.

s24. The first universal switching component forwards the encapsulated inbound service packet to a corresponding second universal switching component.

s25. The second universal switching component performs decapsulation processing on the encapsulated inbound service packet, to obtain the inbound service packet, and transmits the inbound service packet to the to-be-delivered net.

In one embodiment, after receiving the encapsulated inbound service packet forwarded by the first universal switching component, the second universal switching component may perform decapsulation processing on the encapsulated inbound service packet, to obtain the inbound service packet and the address of the to-be-delivered net, and then transmit the inbound service packet to the to-be-delivered net based on the address of the to-be-delivered net.

For ease of understanding, an entire transmission scheduling process of the inbound service packet is described below by using a specific example. FIG. 8b is a schematic flowchart of performing transmission scheduling on an inbound service packet in a cloud network according to an exemplary embodiment of the present disclosure. A transmission scheduling procedure of the inbound service packet includes: 1. A first universal switching component 1 receives an inbound service packet from an ISP network 1, the inbound service packet including an address of a to-be-delivered net 1 in a data center network. 2. The first universal switching component 1 queries, based on the address of the net 1, a local forwarding table of the first universal switching component 1 for forwarding information related to the net 1, the found forwarding information related to the net 1 including a label 1 related to the ISP network 1, and a next hop pointing to a second universal switching component 1. 3. The first universal switching component 1 encapsulates the label 1 in the inbound service packet based on an indication of the found forwarding information, and forwards the encapsulated inbound service packet to a corresponding second universal switching component 1. 4. The second universal switching component 1 may perform decapsulation processing on the encapsulated inbound service packet, to obtain the inbound service packet and the address of the net 1, and transmit the inbound service packet to the net 1 based on the address of the net 1.

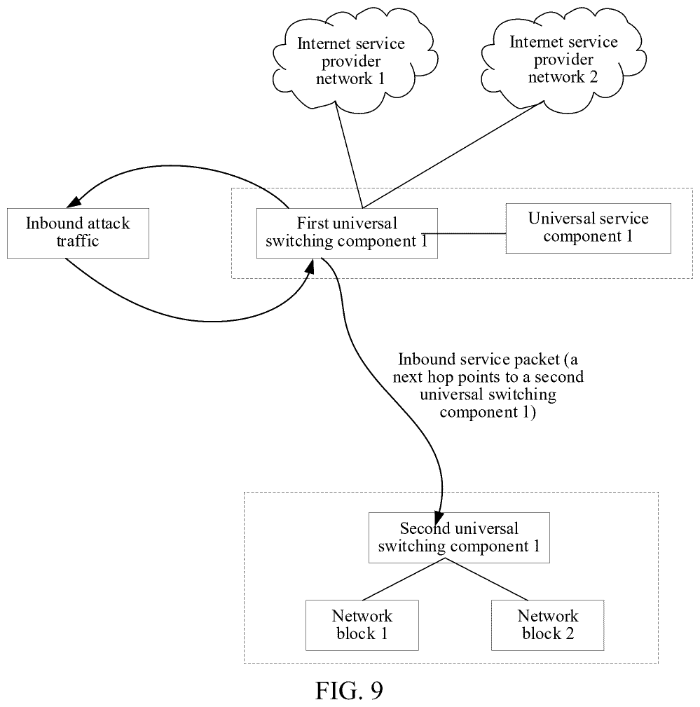

It can be seen from FIG. 8b, transmission scheduling of the inbound service packet is directly processed by the first universal switching component and the second universal switching component, and is not processed by the universal service component (for example, the epp server). Therefore, FIG. 9 is a schematic flowchart of performing transmission scheduling on an inbound attack traffic according to an exemplary embodiment of the present disclosure. When the first universal switching component receives the inbound attack traffic from a network, the inbound attack traffic is traffic configured for attacking a service provided by the data center network. Because all inbound service packets pass through the first universal switching component (that is, processed by hardware), the inbound attack traffic is also processed by the first universal switching component, and there is no risk caused to the universal service component. Security of the universal service component is protected to some extent. The inbound attack traffic may be a distributed denial of service attack (DDos).

In summary, from a perspective that each component in the forwarding system performs transmission scheduling on the inbound service packet and the outbound service packet in the cloud network based on forwarding information in a respective local forwarding table, the first universal switching component and the second universal switching component adopt differential treatment and asymmetric processing for the outbound service packet and the inbound service packet, and TEPE forwarding may be performed on the outbound service packet through the asymmetric processing, to resolve a problem that a stored forwarding entry is insufficient due to limited storage space of the universal switching component in a public network scenario. A T-level forwarding specification is supported, and a routing specification may be reduced, to process millions of routing and forwarding on a switching chip in hundreds of K, thereby achieving high-performance routing and forwarding and flexible transmission scheduling, and satisfying a transmission scheduling requirement of the cloud network.

Next, the transmission scheduling method provided in the embodiments of the present disclosure is described respectively from the first universal switching component, the second universal switching component, and the universal service component.

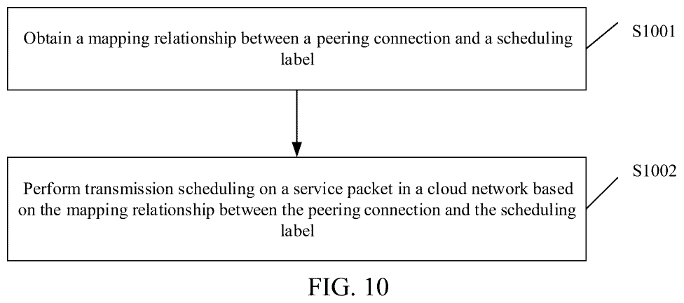

FIG. 10 is a schematic flowchart of a transmission scheduling method according to an exemplary embodiment of the present disclosure. The method may be executed by a first universal switching component in a distributed system, and the transmission scheduling method includes the following operations S1001 to S1003.

S1001. Obtain a mapping relationship between a peer and a label.

In an embodiment, the first universal switching component may be configured to access one or more ISP networks. The first universal switching component may respectively establish peers with accessed ISP networks through the BGP, allocate a mapped label to each peer, and store a mapping relationship between each peer and a label.

S1002. Perform transmission scheduling on a service packet in a cloud network based on the mapping relationship between the peer and the label. The service packet includes an outbound service packet and an inbound service packet.

(1) The service packet includes the outbound service packet, and the performing transmission scheduling on a service packet in a cloud network based on the mapping relationship between the peer and the label includes: 1. Receiving an encapsulated outbound service packet sent by a second universal switching component, the encapsulated outbound service packet being obtained by the second universal switching component encapsulating the outbound service packet with a label related to a to-be-delivered ISP network after receiving the outbound service packet from a data center network. 2. Performing decapsulation processing on the encapsulated outbound service packet, to obtain the outbound service packet, and map, based on the mapping relationship between the peer and the label, the outbound service packet to the to-be-delivered ISP network.

(2) The service packet includes the outbound service packet, and the performing transmission scheduling on a service packet in a cloud network based on the mapping relationship between the peer and the label includes: 1. Receiving an encapsulated outbound service packet forwarded by a universal service component, the encapsulated outbound service packet being obtained by the universal service component encapsulating the outbound service packet with a label related to a to-be-delivered ISP network after receiving the outbound service packet from a second universal switching component. 2. Performing decapsulation processing on the encapsulated outbound service packet, to obtain the outbound service packet, and map, based on the mapping relationship between the peer and the label, the outbound service packet to the to-be-delivered ISP network.

(3) The service packet includes the inbound service packet, and the performing transmission scheduling on a service packet in a cloud network based on the mapping relationship between the peer and the label includes: 1. Receiving the inbound service packet from the ISP network, the inbound service packet including an address of a to-be-delivered network module in the data center network. 2. Querying, based on the address of the to-be-delivered network module, a local forwarding table of the first universal switching component for forwarding information related to the to-be-delivered network module, the local forwarding table of the first universal switching component recording first component forwarding information of the cloud network synchronized as required by the first universal switching component. 3. Encapsulating the label related to the ISP network in the inbound service packet based on an indication of the found forwarding information, and forwarding the encapsulated inbound service packet to a corresponding second universal switching component, so that the second universal switching component performs decapsulation processing on the encapsulated inbound service packet to obtain the inbound service packet, and transmits the inbound service packet to the to-be-delivered network module.

In an embodiment, the transmission scheduling method further includes the following operation. S1003. Receive a routing update message sent by an ISP network accessed to a first universal switching component, add a label to the routing update message, and send the routing update message added with the label to a global routing service node device, so that the global routing service node device transmits, in a routing system in a distributed system, the routing update message added with the label.

In the embodiments of the present disclosure, the first universal switching component performs transmission scheduling on the service packet in the cloud network based on the mapping relationship between the peer and the label, to achieve peer-level scheduling. It no longer needs to achieve high-performance routing and forwarding and flexible transmission scheduling based on millions of public network routing and forwarding, thereby satisfying a transmission scheduling requirement of the cloud network.

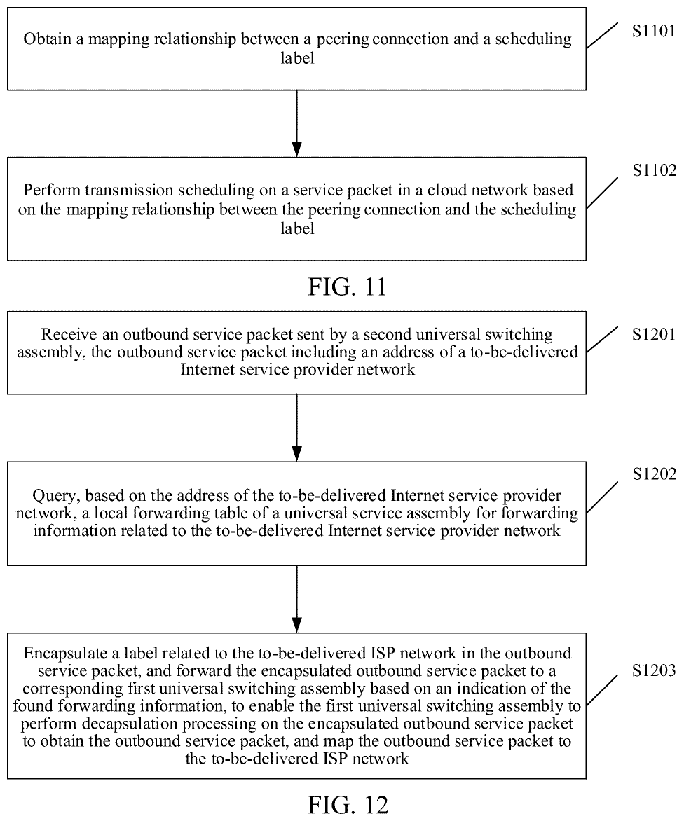

FIG. 11 is a schematic flowchart of a transmission scheduling method according to another exemplary embodiment of the present disclosure. The method may be executed by a second universal switching component in a distributed system, and the transmission scheduling method includes the following operations S1101 to S1102.

S1101. Obtain a mapping relationship between a peer and a label.

In a specific implementation, the second universal switching component may obtain transmitted routing information from a routing system, and the routing information includes the mapping relationship between the peer and the label.

S1102. Perform transmission scheduling on a service packet in a cloud network based on the mapping relationship between the peer and the label. The service packet includes an outbound service packet and an inbound service packet.

(1) The service packet includes the outbound service packet, and the outbound service packet is a service packet transmitted from a data center network to an ISP network. The performing transmission scheduling on a service packet in a cloud network based on the mapping relationship between the peer and the label includes: 1. Receiving the outbound service packet from the data center network, the outbound service packet including an address of a to-be-delivered ISP network. 2. Querying a local forwarding table of the second universal switching component for forwarding information related to the to-be-delivered ISP network. The local forwarding table of the second universal switching component records second component forwarding information of the cloud network synchronized as required by the second universal switching component. 3. If the query succeeds, the second universal switching component encapsulates a label related to the to-be-delivered ISP network in the outbound service packet, and forwards the encapsulated outbound service packet to a corresponding first universal switching component based on an indication of the found forwarding information, so that the first universal switching component performs decapsulation processing on the encapsulated outbound service packet to obtain the outbound service packet, and maps, based on the mapping relationship between the peer and the label, the outbound service packet to the to-be-delivered ISP network. 4. If the query fails, the second universal switching component sends the outbound service packet to a default next hop based on a local forwarding table, the default next hop pointing to the universal service component, so that the universal service component performs encapsulation processing on the outbound service packet based on the address of the to-be-delivered ISP network and the local forwarding table of the universal service component, and forwards the encapsulated outbound service packet to a corresponding first universal switching component.

(2) The service packet includes the inbound service packet, and the performing transmission scheduling on a service packet in a cloud network based on the mapping relationship between the peer and the label includes: 1. Receiving an encapsulated inbound service packet sent by a second universal switching component, the encapsulated inbound service packet being obtained by a first universal switching component encapsulating a label related to an ISP network in the inbound service packet. The inbound service packet includes an address of a to-be-delivered net in a data center network. 2. Performing decapsulation processing on the encapsulated inbound service packet, to obtain the inbound service packet, and transmitting the inbound service packet to the to-be-delivered net based on an address of the to-be-delivered net in the data center network.

In the embodiments of the present disclosure, the second universal switching component performs transmission scheduling on the service packet in the cloud network based on the mapping relationship between the peer and the label, to achieve peer-level scheduling. It no longer needs to achieve high-performance routing and forwarding and flexible transmission scheduling based on millions of public network routing and forwarding, high-performance route-forwarding and flexible transmission scheduling are implemented, thereby satisfying a transmission scheduling requirement of the cloud network.

FIG. 12 is a schematic flowchart of a transmission scheduling method according to another exemplary embodiment of the present disclosure. The transmission scheduling method may be executed by a universal service component in a distributed system, and the transmission scheduling method includes the following operations S1201 to S1203.

S1201. Receive an outbound service packet sent by a second universal switching component. The outbound service packet is a service packet transmitted from a data center network to an ISP network. The outbound service packet includes an address of a to-be-delivered ISP network.

S1202. Query, based on an address of a to-be-delivered ISP network, a local forwarding table of a universal service component for forwarding information related to the to-be-delivered ISP network. The local forwarding table of the universal service component records full forwarding information of the cloud network.

S1203. Encapsulate a label related to the to-be-delivered ISP network in the outbound service packet, and forward the encapsulated outbound service packet to a corresponding first universal switching component based on an indication of the found forwarding information, so that the first universal switching component performs decapsulation processing on the encapsulated outbound service packet to obtain the outbound service packet, and maps the outbound service packet to the to-be-delivered ISP network.

In some embodiments, a flow classification rule and a schedule table are configured in the universal service component, the flow classification rule defining a classification rule of the service packet; and one schedule table is configured for recording transmission information of service packets of one category. The transmission scheduling method further includes the following operation S1024. Classify a service packet in a cloud network based on a flow classification rule, to obtain a category to which the service packet belongs; and perform transmission scheduling on the service packet based on transmission information recorded in a schedule table corresponding to the category. The service packet may include the outbound service packet.

In the embodiments of the present disclosure, the universal service component performs transmission scheduling on the service packet in the cloud network based on the mapping relationship between the peer and the label, to achieve peer-level scheduling. It is no longer need based on millions of public network routing and forwarding, which greatly reduces an Internet routing specification, thereby achieving high-performance routing and forwarding and flexible transmission scheduling, and satisfying a transmission scheduling requirement of the cloud network. In addition, the universal service component is deployed with the flow classification rule and the schedule table, so that refined scheduling based on objects and services can be achieved.

As such, the distributed system in this embodiment of the present disclosure includes a first routing node device, a second routing node device, and a global routing service node device, the first routing node device including a universal service component and a first universal switching component; and the second routing node device including a second universal switching component. It can be learned that in the present disclosure, the distributed system is built by replacing a commercial router with a low-price universal component, so that a large-scale commercial router can be decoupled, operation can be greatly simplified, and operation costs can be reduced, thereby improving scalability and flexibility of the distributed system. In addition, the distributed system may be used in the cloud network. The architecture of the cloud network may include the access network, the backbone network, and the data center network. The first routing node device, the second routing node device, and the global routing service node device are all connected to the backbone network. In this way, the access network and the backbone network may be interconnected through the first routing node device, and the data center network and the backbone network may be interconnected through the second routing node device. In this way, the architecture of the cloud network is opened up through the distributed system, so that networks in the architecture of the cloud network can be interconnected. The first routing node device is distributed in the access network, and is configured to access one or more ISP networks; the second routing node device is distributed in the data center network, and is configured to provide data connection between network modules in the data center network; the global routing service node device is arranged outside the access network and the data center network; and a mapping relationship between a peer (peering connection) and a label (scheduling label) is maintained in the distributed system. The mapping relationship is transmitted between node devices in the distributed system, so that the node devices in the distributed system may obtain the mapping relationship, and may perform transmission scheduling on a service packet in the cloud network based on the mapping relationship. Because transmission scheduling is implemented based on the mapping relationship, and the mapping relationship is a relationship between a peer and a label, the distributed system implements peer-level scheduling, and a quantity of peers is limited. In this way, routing and forwarding pressure in the distributed system can be effectively reduced, high-performance routing and forwarding and flexible transmission scheduling can be achieved, and a transmission scheduling requirement of the cloud network can be satisfied.

A person of ordinary skill in the art may understand that, all or some of the procedures of the method in the foregoing embodiments may be implemented by a computer program instructing relevant hardware. The program may be stored in a computer-readable storage medium. When the program is executed, the procedures of the foregoing method embodiments may be included. The storage medium may be a magnetic disk, an optical disc, a read-only memory (ROM), a random access memory (RAM), or the like.

What is disclosed above is merely exemplary embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. A distributed system, applied to a cloud network, an architecture of the cloud network comprising an access network, a backbone network, and a data center network, the distributed system comprising:
a first routing node device, a second routing node device, and a global routing service node device, that are connected to the backbone network;
the first routing node device being distributed in the access network and being configured to access one or more Internet service provider (ISP) networks, the first routing node device comprising a universal service component and a first universal switching component, the second routing node device being distributed in the data center network and being configured to provide data connection between network modules in the data center network, the second routing node device comprising a second universal switching component, and the global routing service node device being arranged outside the access network and the data center network; and
a mapping relationship between peering connections and scheduling labels being maintained in the distributed system, the mapping relationship being transmitted between node devices in the distributed system, and the node devices performing transmission scheduling of service packet in the cloud network based on the mapping relationship.

2. The distributed system according to claim 1, wherein the access network comprises a plurality of access points, and at least one first routing node device is arranged on one access point; and one first routing node device comprises one first universal switching component and one universal service component, and both the first universal switching component and the universal service component are connected to the backbone network;
the first universal switching component is configured to access one or more ISP networks, respectively establish peering connections to the accessed ISP networks through a network border protocol, and respectively allocate a mapped scheduling label to a peering connection; and
the universal service component is configured to perform scheduling processing of the service packet in the cloud network based on the mapping relationship,
the peering connection being a communication connection established between the first universal switching component and any ISP network to which the first universal switching component is connected, the peering connection being mapped to a corresponding scheduling label, the first universal switching component comprising an edge access switch, and the universal service component comprising an elastic packet processing server.

3. The distributed system according to claim 1, wherein the data center network comprises a plurality of availability zones, an availability zone comprises one or more network modules, and at least one second routing node device is arranged in each availability zone; and one second routing node device comprises at least one second universal switching component, and the second universal switching component is connected to the backbone network; and
the second universal switching component is respectively connected to network modules belonging to a same availability zone, and is configured to provide data connection to the network modules belonging to the same availability zone, the second universal switching component comprising an internal aggregate switch.

4. The distributed system according to claim 1, wherein the global routing service node device comprises an elastic routing service server, and a global routing service program is deployed in the elastic routing service server; and
the global routing service program in the elastic routing service server is deployed in a physical manner or a virtual manner.

5. The distributed system according to claim 1, wherein routing service instances are respectively deployed in the universal service component, the first universal switching component, and the second universal switching component;
the distributed system further comprises a routing system, and the routing system comprises the global routing service node device and the routing service instance deployed in the distributed system; and
the node devices in the distributed system exchange routing information of the cloud network in the routing system; and the routing information comprises the mapping relationship.

6. The distributed system according to claim 5, wherein the global routing service node device in the routing system collects the routing information of the cloud network, and transmits the routing information of the cloud network to components in the routing system; and the components in the routing system include a component in the distributed system in which the routing service instance is deployed;
the global routing service node device transmits updated routing information to the components in the routing system when the routing information of the cloud network is updated; and
the global routing service node device and the components in the routing system store full routing information of the cloud network based on the transmission, routing information related to the peering connection comprising the scheduling label mapped to the peering connection.

7. The distributed system according to claim 6, wherein the distributed system comprises a forwarding system, and the forwarding system comprises a forwarding plane of the universal service component, a forwarding plane of the first universal switching component, and a forwarding plane of the second universal switching component; and the universal service component, the first universal switching component, and the second universal switching component are components in the forwarding system; and
the node devices in the distributed system perform transmission scheduling of the service packet in the cloud network based on the mapping relationship in the forwarding system.

8. The distributed system according to claim 6, wherein the universal service component, the first universal switching component, and the second universal switching component each store the full routing information of the cloud network; and the routing information related to the peering connection comprises the scheduling label mapped to the peering connection;
the universal service component synchronizes, based on the full routing information, the full forwarding information of the cloud network on the forwarding plane of the universal service component;
the first universal switching component synchronizes, based on the full routing information, first component forwarding information of the cloud network on the forwarding plane of the first universal switching component as required; and
the second universal switching component receives the full routing information, and synchronizes second component forwarding information of the cloud network on the forwarding plane of the second universal switching component as required,
the first component forwarding information comprising forwarding information related to the ISP network accessed to the first universal switching component, and the second component forwarding information comprising forwarding information related to network modules in the same availability zone as the second universal switching component.

9. The distributed system according to claim 8, wherein the full forwarding information of the cloud network synchronized by the universal service component is stored in a local forwarding table of the universal service component;
the first component forwarding information of the cloud network synchronized as required by the first universal switching component is stored in a local forwarding table of the first universal switching component;
the second component forwarding information of the cloud network synchronized as required by the second universal switching component is stored in a local forwarding table of the second universal switching component; and
the components in the forwarding system perform, based on forwarding information in a respective local forwarding table, transmission scheduling of the service packet in the cloud network.

10. The distributed system according to claim 9, wherein the transmission scheduling comprises:
querying, by any component when the service packet in the cloud network reaches the any component in the forwarding system, the local forwarding table of the component for forwarding information required for transmission;
encapsulating, by the any component if the query succeeds, a scheduling label related to transmission in the service packet based on the found forwarding information, and performing forwarding processing on the service packet based on an indication of the found forwarding information; and
transmitting, by the any component if the query fails, the service packet to a default next hop, and performing, by a component to which the default next hop points, transmission scheduling on the service packet.

11. The distributed system according to claim 1, wherein a flow classification rule and a schedule table are configured in the universal service component, and the flow classification rule defines a classification rule of the service packet; one schedule table is configured for recording transmission information of service packets of one category; and the transmission scheduling comprises:
classifying, by the universal service component, the service packet in the cloud network based on the flow classification rule, to obtain a category to which the service packet belongs; and performing transmission scheduling of the service packet based on transmission information recorded in a schedule table corresponding to the category to which the service packet belongs.

12. A transmission scheduling method, applied to the a distributed system that includes a first routing node device, a second routing node device, and a global routing service node device, that are connected to a backbone network; the first routing node device being distributed in an access network and being configured to access one or more Internet service provider (ISP) networks, the first routing node device comprising a universal service component and a first universal switching component, the second routing node device being distributed in a data center network and being configured to provide data connection between network modules in the data center network, the second routing node device comprising a second universal switching component, and the global routing service node device being arranged outside the access network and the data center network; and a mapping relationship between peering connections and scheduling labels being maintained in the distributed system, the mapping relationship being transmitted between node devices in the distributed system, and the node devices performing transmission scheduling of service packet in the cloud network based on the mapping relationship, the method comprising:
obtaining the mapping relationship between the peering connection and the scheduling label;
transmitting the mapping relationship between the node devices in the distributed system; and
performing transmission scheduling on the service packet in the cloud network based on the mapping relationship.

13. The method according to claim 12, wherein the service packet in the cloud network comprises an outbound service packet, and the outbound service packet is a service packet transmitted from the data center network to the ISP network; and the performing transmission scheduling on the service packet in the cloud network based on the mapping relationship comprises:
receiving, by the second universal switching component, the outbound service packet from the data center network, the outbound service packet comprising an address of a to-be-delivered ISP network;
querying, by the second universal switching component based on the address of the to-be-delivered ISP network, the local forwarding table of the second universal switching component for forwarding information related to the to-be-delivered ISP network, the local forwarding table of the second universal switching component recording second component forwarding information of the cloud network synchronized as required by the second universal switching component;
encapsulating, by the second universal switching component, a scheduling label related to the to-be-delivered ISP network in the outbound service packet if the query succeeds, and forwarding the encapsulated outbound service packet to a corresponding first universal switching component based on an indication of the found forwarding information; and
performing, by the first universal switching component, decapsulation processing on the encapsulated outbound service packet, to obtain the outbound service packet, and mapping the outbound service packet to the to-be-delivered ISP network based on the mapping relationship between the peering connection and the scheduling label.

14. The method according to claim 13, further comprising:
transmitting, by the second universal switching component, the outbound service packet to the default next hop if the query fails, the default next hop pointing to the universal service component;
querying, by the universal service component based on the address of the to-be-delivered ISP network, the local forwarding table of the universal service component for the forwarding information related to the to-be-delivered ISP network, the local forwarding table of the universal service component recording full forwarding information of the cloud network;
encapsulating, by the universal service component, the scheduling label related to the to-be-delivered ISP network in the outbound service packet, and forwarding the encapsulated outbound service packet to a corresponding first universal switching component based on an indication of the found forwarding information; and
performing, by the first universal switching component, decapsulation processing on the encapsulated outbound service packet, to obtain the outbound service packet, and mapping the outbound service packet to the to-be-delivered ISP network based on the mapping relationship between the peering connection and the scheduling label.

15. The method according to claim 14, wherein the service packet in the cloud network comprises an inbound service packet, and the inbound service packet is a service packet transmitted from the ISP network to the data center network; and the performing transmission scheduling on the service packet in the cloud network based on the mapping relationship comprises:
receiving, by the first universal switching component, an inbound service packet from the ISP network, the inbound service packet comprising an address of a to-be-delivered network module in the data center network;
querying, by the first universal switching component based on the address of the to-be-delivered network module, the local forwarding table of the first universal switching component for forwarding information related to the to-be-delivered network module, the local forwarding table of the first universal switching component recording first component forwarding information of the cloud network synchronized as required by the first universal switching component;
encapsulating, by the first universal switching component, a scheduling label related to the ISP network in the inbound service packet based on the indication of the found forwarding information, and forwarding the encapsulated inbound service packet to a corresponding second universal switching component; and
performing, by the second universal switching component, decapsulation processing on the encapsulated inbound service packet, to obtain the inbound service packet, and transmitting the inbound service packet to the to-be-delivered network module.

16. The method according to claim 12, wherein the access network comprises a plurality of access points, and at least one first routing node device is arranged on one access point; and one first routing node device comprises one first universal switching component and one universal service component, and both the first universal switching component and the universal service component are connected to the backbone network;
the first universal switching component is configured to access one or more ISP networks, respectively establish peering connections to the accessed ISP networks through a network border protocol, and respectively allocate a mapped scheduling label to a peering connection; and
the universal service component is configured to perform scheduling processing of the service packet in the cloud network based on the mapping relationship,
the peering connection being a communication connection established between the first universal switching component and any ISP network to which the first universal switching component is connected, the peering connection being mapped to a corresponding scheduling label, the first universal switching component comprising an edge access switch, and the universal service component comprising an elastic packet processing server.

17. The method according to claim 12, wherein the data center network comprises a plurality of availability zones, an availability zone comprises one or more network modules, and at least one second routing node device is arranged in each availability zone; and one second routing node device comprises at least one second universal switching component, and the second universal switching component is connected to the backbone network; and
the second universal switching component is respectively connected to network modules belonging to a same availability zone, and is configured to provide data connection to the network modules belonging to the same availability zone,
the second universal switching component comprising an internal aggregate switch.

18. The method according to claim 12, wherein the global routing service node device comprises an elastic routing service server, and a global routing service program is deployed in the elastic routing service server; and
the global routing service program in the elastic routing service server is deployed in a physical manner or a virtual manner.

19. The method according to claim 12, wherein routing service instances are respectively deployed in the universal service component, the first universal switching component, and the second universal switching component;
the distributed system further comprises a routing system, and the routing system comprises the global routing service node device and the routing service instance deployed in the distributed system; and
the node devices in the distributed system exchange routing information of the cloud network in the routing system; and the routing information comprises the mapping relationship.

20. A non-transitory computer-readable storage medium containing a computer program that, when being executed, causes one or more processors to perform a transmission scheduling method, applied to a distributed system that includes a first routing node device, a second routing node device, and a global routing service node device, that are connected to a backbone network; the first routing node device being distributed in an access network and being configured to access one or more Internet service provider (ISP) networks, the first routing node device comprising a universal service component and a first universal switching component, the second routing node device being distributed in a data center network and being configured to provide data connection between network modules in the data center network, the second routing node device comprising a second universal switching component, and the global routing service node device being arranged outside the access network and the data center network; and a mapping relationship between peering connections and scheduling labels being maintained in the distributed system, the mapping relationship being transmitted between node devices in the distributed system, and the node devices performing transmission scheduling of service packet in the cloud network based on the mapping relationship, the method comprising:
obtaining the mapping relationship between the peering connection and the scheduling label;
transmitting the mapping relationship between the node devices in the distributed system; and
performing transmission scheduling on the service packet in the cloud network based on the mapping relationship.
